(19) United States
(12) Patent Application Publication
(10) Pub. No.: US 2009/0151620 A1
(43) Pub. Date: Jun. 18, 2009

(54) Display device for displaying variables, parameters etc. in an analog manner

(76) Inventor: Thomas Moosmann, Fluorn-Winzeln (DE)

Correspondence Address: K.F. ROSS P.C., 5683 RIVERDALE AVENUE, SUITE 203 BOX 900, BRONX, NY, 10471-0900, US

(21) Appl. No.: 11/989,315

(22) PCT Filed: May 16, 2006
(86) PCT No.: PCT/EP2006/004590

§ 371 Date: Jan. 22, 2008

(30) Foreign Application Priority Data
Jul. 20, 2005 (DE) 10 2005 033 888.7

(51) Int. Cl. G01D 11/28

(52) U.S. Cl. 116/288

(57) ABSTRACT

The invention relates to a display device (1) for displaying variables, parameters etc. in an analog manner. Said display device comprises a stepper motor (2), a display element (3) which can be adjusted by means of the stepper motor (2), an electronic part (4) which can capture the signals corresponding to the variables, parameters etc. which can be displayed, and the stepper motor (2) which corresponds to the captured signals can be controlled and/or adjusted, and an LED (9) which can be illuminated by means of the display element (3). The LED (9) is embodied in such a way that it can radiate various colours by means of the light radiation thereof, in order to broaden the uses of the display device (1) with a comparatively low technical-constructive expenditure.

The invention relates to a display for showing amplitudes, parameters etc. in an analog manner, with a stepper motor, a pointer that can be moved by means of the stepper motor, an electronic circuit by means of which signals can be received corresponding to the amplitudes, parameters etc. that can be displayed, and by means of which the stepper motor can be controlled and/or adjusted in accordance with the received signals, and an LED by means of which the pointer can be illuminated.

Such displays can be used to represent virtually any desired parameters, amplitudes, etc. of a technical, physical, chemical, biological or other nature in such a way that a value of the respective amplitude or parameter can be read from the display, while the visibility of the display can be enhanced by means of the illuminated display, as shown for example in EP 1 371 522 A2.

Starting from the above-described prior art, the object underlying the invention is to create a display that, with the lowest possible technical-constructive expenditure, offers a much greater range with regard to representation of parameters, amplitudes, etc. and/or by which the different values related to a amplitude or parameter can be displayed in a comparatively large value range much more clearly than in the prior art.

This task is solved according to the invention by the fact that the LED used as a light source for illumination of the pointer is designed in such a way that, by means of it, light can be emitted in various colors. The LED of the display according to the invention is controlled, in terms of the color of the light emitted from it, by means of the electronic circuit of the display, with certain colors of the light emitted from the LED being assigned to certain informational content.

Thus it is possible, for example, for different colors of the light radiation that can be emitted using the LED to be assigned to different amplitudes, parameters, etc. that can be represented by means of the display. Then using one and the same display, a number of amplitudes, parameters, etc. can be displayed that is equivalent to the number of available colors, and at the same quality level.

Furthermore, it is possible, for different colors of the light radiation that can be emitted using the LED to be assigned to different magnitude ranges of the amplitudes or parameters to be displayed by means of the display. In this way, the corresponding parameter or amplitude can be represented across an extended value range more precisely than with displays known from the prior art, while the technical apparatus-related expenditure remains practically unchanged.

A two-phase stepper motor can be advantageously used as a stepper motor.

In order to effect the movement of the pointer in a simple manner by means of the stepper motor, it is advantageous if the stepper motor has a journal in which the pointer is held. Thus movement of the pointer can be effected in a simple manner by means of a driven rotor of the stepper motor.

In this case, the pointer can be advantageously designed as an indicator, with the pointer having a first part projecting into the journal of the stepper motor and a second part that is bent with respect to the first and that in combination with a scale displays the value of the amplitude to be represented by means of the display.

In order to feed the light emitted by the LED as completely as possible into the pointer or pointer, it is advantageous if the LED is positioned at that end of the journal of the stepper motor that faces the electronic circuit.

Then the LED can be positioned directly at that end of the pointer that is adjacent the stepper motor, radiation losses being minimized by such positioning.

Alternatively, the LED can be a component of the electronic circuit of the display or else of its stepper motor.

The invention is explained in greater-detail below, based on an embodiment and with reference to the drawing.

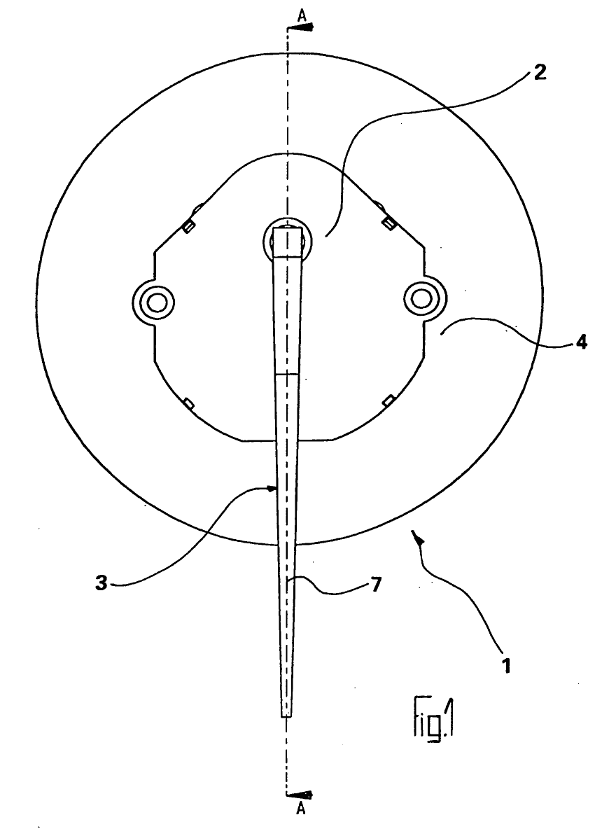

FIG. 1 shows a front view of an embodiment of a display according to the invention, and

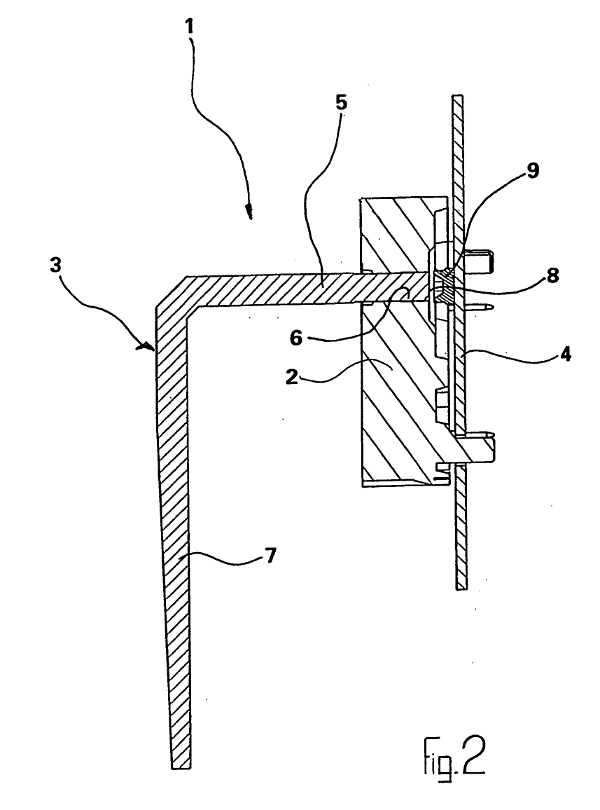

FIG. 2 shows the cross-section A-A of FIG. 1.

FIGS. 1 and 2 show schematically an embodiment of a display 1 according to the invention, which is used to represent any desired technical, physical, chemical, biological, etc. amplitudes and/or parameters in an analog manner.

To do so, the display 1 has, in the illustrated embodiment, a two-phase stepper motor 2, a pointer 3 as indicator and an electronic circuit 4.

The two-phase stepper motor 2, illustrated only schematically in the figures, is used to move the pointer 3. The pointer 3 has, in the illustrated embodiment, a first part 5 that projects into a journal 6 of the two-phase stepper motor 2. The first part 5 of the pointer 3 can pivot in the journal 6. A driven member, not shown in the figures, of the two-phase stepper motor 2 pivots the first part 5 and thus swings a second part 7 of the pointer 3, with the value of the amplitude, parameter etc. being displayed by means of the combined effect of the second part 7 of the pointer 3 relative to a scale or the like.

In the illustrated embodiment, the pointer 3 is transparent or translucent. At that end of the pointer 3 adjacent the stepper motor, an end face 8 of the first part 5 confronts a light source in the form of an LED that radiates light directly into the transparent pointer 3. The pointer 3 is illuminated by the light emitted from the LED 9.

In the embodiment illustrated in FIGS. 1 and 2, the LED 9 is part of an electronic circuit 4 of the display 1. When the two-phase stepper motor 2 is connected to the electronic circuit 4, the LED 9 comes into position confronting the end face 8 of the first part 5 of the pointer 3.

The electronic circuit 4 receives signals that correspond to amplitudes, parameters etc. to be displayed by means of the display 1. These received signals are processed in the electronic circuit 4 and used to drive the two-phase stepper motor 2 that can thereby be controlled and/or adjusted in accordance with the signals received by electronic circuit 4.

The LED 9 is designed in such a way that it can emit light in various colors. The color of the light to be emitted from the LED 9 is also set by means of electronic circuit 4, with the signals received by electronic circuit 4 being responsible also for determining the color.

It is possible for different colors of LED 9 to be assigned to different amplitudes or parameters to be displayed by means of the display 1. Then a comparatively large number of amplitudes, parameters etc. can be represented with one and the same display 1, with each color of the pointer 3 being assigned to a certain amplitude or parameter.

Alternatively or in addition, it is possible for different colors of LED 9 to be assigned to different magnitude ranges of amplitude or parameter to be displayed. Thus it is possible to display the current precisely and very clearly across a considerably larger value range of an amplitude or parameter to be displayed by means of the display 1, than is the case in the prior art.

Of course, it is also possible to represent, by different colors of the light emitted by LED 9, different physical conditions of a substance or the like, to be shown with respect to a parameter by means of the display 1.

A measuring device, which is not shown in the figures and which is equipped with the display 1 described above, can be furnished with instructions that indicate what colors of the pointer are assigned to what amplitudes, parameters, etc. or magnitude ranges.

1. A display for displaying amplitudes, parameters etc. in an analog manner, with a stepper motor, a pointer that can be moved by means of the stepper motor, an electronic circuit that receives signals corresponding to the amplitudes, parameters etc. that can be displayed, and by means of which the stepper motor can be controlled and/or adjusted in accordance with the received signals, and an LED by means of which the pointer can be illuminated, characterized in that the LED is designed in such a way that, by means of it, light radiation can be emitted in various colors.

2. The display of claim 1 wherein the stepper motor is designed as a two-phase stepper motor.

3. The display of claim 1 wherein the stepper motor has a journal in which the pointer is held.

4. The display of claim 1 wherein the pointer is designed as an indicator.

5. The display of claim 4 wherein the LED is positioned at that end of the journal of the stepper motor that is juxtaposed with the electronic circuit.

6. The display of claim 1 wherein the LED is a component of the stepper motor.

7. The display of claim 1 wherein the LED is a component of the electronic circuit of the display.

8. The display of claim 1 wherein different colors of the light radiation that can be emitted using the LED are assigned to different amplitudes, parameters, etc. that can be represented by means of the display.

9. The display of one claim 1 wherein different colors of the light radiation that can be emitted using the LED are assigned to different magnitude ranges or a amplitude, parameter, etc. that can be represented by means of the display.

10. The display of claim 1 wherein the LED is positioned directly at that end of the pointer that is adjacent the stepper motor.
